(19) United States
(12) Patent Application Publication
(10) Pub. No.: US 2024/0405929 A1
(43) Pub. Date: Dec. 5, 2024

(54) METHOD, APPARATUS, DEVICE, AND MEDIUM FOR TRANSMITTING DATA

(71) Applicant: Beijing Bytedance Network Technology Co., Ltd., Beijing (CN)

(72) Inventors: Bin XU, Beijing (CN); Hao WU, Beijing (CN)

(21) Appl. No.: 18/699,573

(22) PCT Filed: Nov. 1, 2022
(86) PCT No.: PCT/CN2022/128847

§ 371 Date: Apr. 8, 2024

(30) Foreign Application Priority Data
Nov. 8, 2021 (CN) 202111313978.X

(51) Int. Cl. H04L 1/1867; H04L 67/10; H04L 67/131

(52) U.S. Cl. CPC H04L 1/1887; H04L 67/10; H04L 67/131

(57) ABSTRACT

Disclosed in the present disclosure are a method and apparatus for transmitting data, a device, and a medium. The method for transmitting data applied to a client end includes: determining, in response to a trigger operation on a target cloud game, an instruction type of an original operation instruction corresponding to the trigger operation; configuring the original operation instruction with a corresponding protection instruction according to the instruction type to obtain a target operation instruction; and transmitting the target operation instruction to a server end. In examples, the protection instruction is added to combat packet loss and jitter of a network, such that a packet loss concealment delay is reduced on the basis of better utilizing a large amount of remaining uplink bandwidth, and packet loss concealment can be completed with a low delay.

### CROSS-REFERENCE TO RELATED APPLICATION(S)

The disclosure claims the priority to the Chinese Patent Application No. 202111313978.X, filed to the Chinese Patent Office on Nov. 8, 2021, which is incorporated in its entirety herein by reference.

### FIELD

The present disclosure relates to the field of data processing, and particularly relates to a method, apparatus, and device and storage medium for processing data.

### BACKGROUND

In a cloud game application scene, a user response delay is an important indicator of cloud game service quality. In order to guarantee the reliability of instruction data, the data can be transmitted using an acknowledge (ACK) mechanism (performing packet-by-packet ACK, that is, performing timeout retransmission by a sender in case of packet loss) of a transmission control protocol (TCP), a selective ACK (SACK) mechanism (actively initiating SACK to notify the sender of a packet loss state in case of a disordered packet received by a receiver) of a stream control transmission protocol (SCTP), or a non-acknowledgement (NACK) mechanism (initiating NACK once at a fixed time by the receiver to notify the sender of the packet loss state) of a user datagram protocol (UDP). Using the above strategies introduces a large delay on the basis of guaranteeing that the instruction data is reachable. However, a user is typically the most sensitive to the delay when operating, and once a user operation instruction is lost in a transmission process, the increased delay will greatly reduce the user experience. Besides an Automatic Repeat-reQuest (ARQ) mechanism (which initiates retransmission by calculating packet loss after feedback in the form of ACK or NACK) for guaranteeing the reliability of data, the data is also protected by increasing redundancy to a certain extent in combination with forward error correction (FEC). Although a delay is shorter compared to ARQ, FEC encoding and decoding adds a short delay and brings additional arithmetic consumption, and the delay is further increased by waiting for packets that have reached recovery conditions to complete FEC decoding when reorganizing and recovering the data.

### SUMMARY

Examples of the present disclosure provide a method, apparatus, device, and medium for transmitting data, achieving packet loss concealment with a low delay.

In a first aspect, an example of the present disclosure provides a method for transmitting data, applied to a client end, and including:
determining, in response to a trigger operation on a target cloud game, an instruction type of an original operation instruction corresponding to the trigger operation;
configuring the original operation instruction with a corresponding protection instruction according to the instruction type to obtain a target operation instruction; and
transmitting the target operation instruction to a server end.

In a second aspect, an example of the present disclosure further provides an apparatus for transmitting data, applied to a client end, and including:
a first determination module configured to determine, in response to a trigger operation on a target cloud game, an instruction type of an original operation instruction corresponding to the trigger operation;
a second determination module configured to configure the original operation instruction with a corresponding protection instruction according to the instruction type to obtain a target operation instruction; and
a transmission module configured to transmit the target operation instruction to a server end.

In a third aspect, an example of the present disclosure further provides an electronic device, including:
one or more processors; and
a memory configured to store one or more programs; where
when the one or more programs are executed by the one or more processors, the one or more processors implement the method for transmitting data according to any one of the above examples.

In a fourth aspect, an example of the present disclosure further provides a computer storage medium, storing a computer program. The computer program implements the method for transmitting data according to any one of the above examples when executed by a processor.

According to the present disclosure, the corresponding protection instruction is configured according to the instruction type of the original operation instruction, the target operation instruction is obtained, and then the target operation instruction is transmitted to the server end. The protection instruction is added to combat packet loss and jitter of a network, such that a packet loss concealment delay is reduced on the basis of better utilizing a large amount of remaining uplink bandwidth, and packet loss concealment can be completed with low delay.

### BRIEF DESCRIPTION OF THE DRAWINGS

The above and other features, advantages, and aspects of examples of the present disclosure will become more apparent with reference to the following particular embodiments in conjunction with the drawings. The same or similar reference numerals refer to the same or similar elements throughout the drawings. It should be understood that the drawings are schematic, and that the parts and elements are not necessarily drawn to scale.

FIG. 1 is a schematic diagram of a cloud game architecture provided in the prior art;

FIG. 2 is a flowchart of a method for transmitting data provided in an example of the present disclosure;

FIG. 3 is a flowchart of another method for transmitting data provided in an example of the present disclosure;

FIG. 4 is a flowchart of yet another method for transmitting data provided in an example of the present disclosure;

FIG. 5 is a flowchart of yet another method for transmitting data provided in an example of the present disclosure;

FIG. 6 is a flowchart of yet another method for transmitting data provided in an example of the present disclosure;

FIG. 7 is a schematic diagram of transmission with a redundant instruction as a protection instruction provided in an example of the present disclosure;

FIG. 8 is a schematic diagram of transmission with a repeat instruction as a protection instruction provided in an example of the present disclosure;

FIG. 9 is a structural block diagram of an apparatus for transmitting data provided in an example of the present disclosure; and

FIG. 10 is a structural block diagram of an electronic device provided in an example of the present disclosure.

### DETAILED DESCRIPTION OF EMBODIMENTS

Examples of the present disclosure are described in more detail below with reference to the drawings. Although some examples of the present disclosure are shown in the drawings, it should be understood that the present disclosure may be embodied in various forms and should not be construed as being limited to the examples set forth herein. On the contrary, these examples are provided, such that the present disclosure will be understood more thoroughly and completely. It should be understood that the drawings and examples of the present disclosure are for illustrative purposes merely and are not intended to limit the scope of protection of the present disclosure.

It should be understood that various steps recited in the method embodiments of the present disclosure can be performed in different orders and/or in parallel. Furthermore, the method embodiments can include additional steps and/or omit to execute the illustrated steps. The scope of the present disclosure is not limited in this respect.

As used herein, the term “comprise” or “include” and their variations are open-ended, that is, “comprise but not limited to” and “include but not limited to”. The term “based on” is “based at least in part on”. The term “an example” means “at least one example”. The term “another example” means “at least one further example”. The term “some examples” means “at least some examples”. Definitions for other terms are given in the description below.

It should be noted that concepts such as “first” and “second” mentioned in the present disclosure are merely used to distinguish different apparatuses, modules or units, and are not used to limit the order of functions executed by these apparatuses, modules or units or their interdependence.

It should be noted that the modification with “a”, “an” or “a plurality of” in the present disclosure is intended to be illustrative rather than limitative, and should be understood by those skilled in the art as “one or more” unless the context clearly dictates otherwise.

The names of messages or information exchanged between a plurality of apparatuses in the embodiments of the present disclosure are merely for illustrative purposes, and are not intended to limit the scope of these messages or information.

In a cloud game application scene, a user response delay is an important indicator of cloud game service quality. A complete response delay link consists of several stages: a user clicks on a cloud game screen, a client end uploads a user instruction to a server end, the server end inputs an instruction to render a game, a rendered audio and video are encoded and then transmitted to the client end, the client end decodes the audio and video and renders them, and the user perceives picture and sound changes caused by the click. Delays caused by game rendering, encoding and decoding stages are relatively fixed, which has a relatively small degradation effect on cloud game service quality finally presented to the user. Instruction and audio and video transmission stages depend on a state of a network link between the client end and the server end, and the state of the network link may be in congestion due to a change of background traffic at any time. A transmission delay of audio and video data becomes longer, which finally leads to the user response delay becoming longer, influencing the cloud game service quality. Although in the audio and video transmission stage, media data has strong dependence on data integrity and order, packet loss and disorder of audio and video data in a weak network environment are the most important factors influencing a user response delay. Due to the high reliability of instruction data, packet loss still introduces a considerable delay for a final response delay.

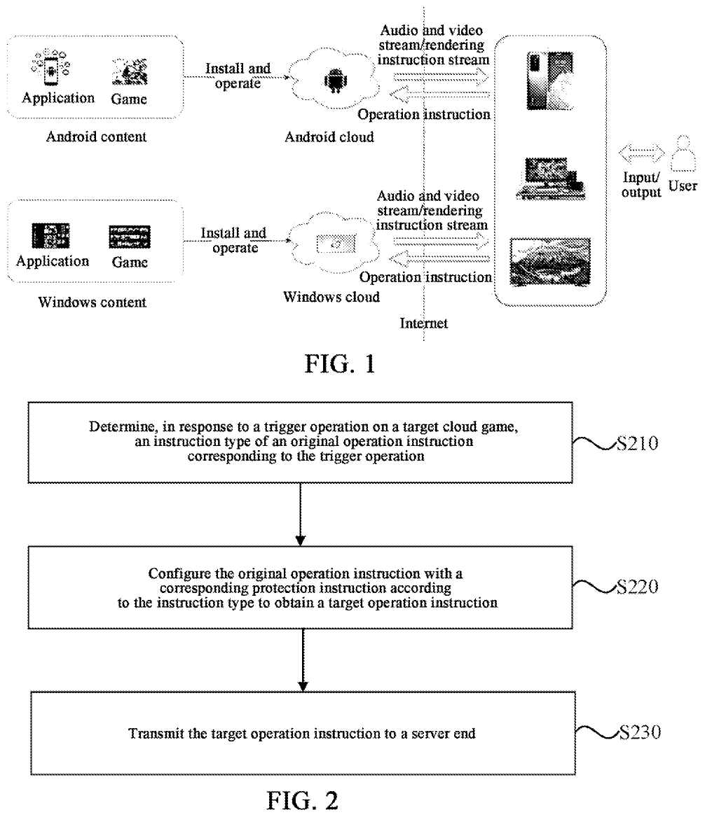

Instruction data refers to system instruction data generated by a user input operation in a terminal device. FIG. 1 is a schematic diagram of a cloud game architecture provided in the prior art. As shown in FIG. 1, in the cloud game architecture, instruction data is transmitted from a user side to a cloud server via a network, which is called uplink transmission, and an audio and video stream or a rendering instruction stream is transmitted downlink. For example, an uplink data size is 100 kbps-1 M, and a downlink data size is 6 Mbps-30 Mbps.

The specific instruction data includes operation instructions such as pressing a button, sliding a screen, releasing a button by a user, etc. Loss of a single instruction in a transmission process, disorder, etc., block update of game logic, increase a delay of a subsequent video stream, and greatly reduce a user experience effect.

In order to guarantee reliability of instruction data, current solutions adopted by the industry include:

Transmission control protocol (TCP): based on an acknowledge (ACK) mechanism, ACK is performed packet by packet, and when a packet is lost, a sender performs timeout retransmission.

Stream control transmission protocol (SCTP): based on a selective acknowledge (SACK) mechanism, when receiving a disordered packet, a receiver initiates SACK to notify a sender of a packet loss state.

User datagram protocol (UDP) & non-acknowledgement (NACK): based on a NACK mechanism, a receiver initiates NACK once at a fixed time to notify a sender of a packet loss state.

Specifically, the TCP and a TCP-based transmission protocol, such as websocket, are based on a timeout retransmission mechanism, and an additional delay introduced is timeout retransmission delay+instruction retransmission uplink delay. The SCTP is based on the SACK mechanism, and packet retransmission introduces a delay of at least one round-trip time (RTT). The UDP & NACK introduces a delay of RTT+partial NACK period. Using the above strategies introduces a large delay on the basis of guaranteeing that the instruction data is reachable. However, a user is typically the most sensitive to the delay when operating, and once a user operation instruction is lost in a transmission process, the increased delay will greatly reduce the user experience. Besides an automatic repeat-request (ARQ) mechanism (which initiates retransmission by calculating packet loss after feedback in the form of ACK or NACK) for guaranteeing the reliability of data, the data is also protected by increasing redundancy to a certain extent in combination with forward error correction (FEC). Although a delay is shorter compared to ARQ, FEC encoding and decoding adds a short delay and brings additional arithmetic consumption, and the delay is further increased by waiting for packets that have reached recovery conditions to complete FEC decoding when reorganizing and recovering the data.

In view of this, the example of the present disclosure provides a method for transmitting data. By designing a reliable cloud game instruction transmission channel with a low packet loss concealment delay, packet loss concealment can still be completed with a small delay even in the case of instruction data packet loss.

FIG. 2 is a flowchart of another method for transmitting data provided in an example of the present disclosure. The method may be executed by an apparatus for transmitting data configured in an electronic device. The example is applied to a scene of avoiding network packet loss and jitter. The electronic device may be a client end, and preferably may be an intelligent terminal, such as a smart phone or an iPad, capable of running a cloud game. As shown in FIG. 2, the method in the example includes:

S210, determine, in response to a trigger operation on a target cloud game, an instruction type of an original operation instruction corresponding to the trigger operation.

The cloud game is a cloud-computing-based gaming mode where a game user can enter the game by following a client-side program. The program can access a server running the game, such that the user can play the game on the server. In the example, the target cloud game refers to a game running on the client end and currently being operated by the user. When the trigger operation by the game user on the target cloud game is received, an operation instruction corresponding to the trigger operation is generated as the original operation instruction. Illustratively, the trigger operation on the target cloud game refers to a click operation on an operation control configured on a display interface where the target cloud game is located. Illustratively, the trigger operation may include operations such as clicking a menu bar and game settings, and may also include operations such as sliding a touch screen by a user. The operation of sliding a touch screen by a user may be completed by three trigger events. Illustratively, the operation of sliding a touch screen by a user may include the following three events: action_down, action_move, and action_up, or may be three instructions, and the three instructions constitute an operation of an independent action, which is not limited. action_down refers to triggering when a first finger touches the screen for the first time, action_move refers to triggering when the finger interacts on the screen, that is, triggering may be implemented a plurality of times, and action_up refers to triggering when a last finger leaves the screen.

It can be understood that the original operation instruction refers to a corresponding operation instruction generated by an actual trigger operation of the user on the target cloud game. That is, the original operation instruction is an instruction actually sent by the client end. It should be noted that each original operation instruction corresponds to a service packet. Certainly, the original operation instruction may also correspond to a plurality of service packets, and may be configured according to actual operations, which is not limited.

Since the user can execute a plurality of trigger operations on the target cloud game, that is, different trigger operations generate different original operation instructions. An instruction type of each original operation instruction is determined. Illustratively, the instruction types may include a frequent operation instruction, and an infrequent operation instruction. In the example, the frequent operation instruction refers to an instruction with a shorter operation interval between two instructions. The infrequent operation instruction refers to an instruction with a longer operation interval between two instructions.

S220, configure the original operation instruction with a corresponding protection instruction according to the instruction type to obtain a target operation instruction.

The protection instruction may be understood as an instruction that can be used to have an anti-packet-loss effect on transmission of the original operation instruction. Illustratively, the protection instruction may be a redundant instruction, a repeat instruction, or a retransmission instruction. The redundant instruction refers to a copy of a transmitted instruction appended to the original operation instruction. The repeat instruction refers to an instruction actively and repeatedly sent. The retransmission instruction refers to an instruction passively retransmitted in response to a NACK request. In the example, in order to configure a matching protection instruction for the original operation instruction to achieve a better anti-packet-loss effect, a corresponding protection instruction may be configured according to the instruction type of each original operation instruction. It can be understood that the protection instructions corresponding to the original operation instructions of different instruction types are also different, and configuration methods corresponding to the protection instructions are also different. It can be understood that the target operation instruction may include both the original operation instruction and the protection instruction, or only include the protection instruction.

S230, transmit the target operation instruction to a server end.

In the example, after determining the target operation instruction corresponding to the original operation instruction, the client end transmits the target operation instruction to the associated server end. In an actual transmission process, the original operation instruction and the protection instruction may be sent to the server end simultaneously. The original operation instruction and the protection instruction may also be sent to the server end separately, that is, the original operation instruction is sent first, and then the protection instruction is sent to the server end.

According to the technical solution of the example, the corresponding protection instruction is configured according to the instruction type of the original operation instruction, the target operation instruction is obtained, and then the target operation instruction is transmitted to the server end. The protection instruction is added to combat packet loss and jitter of a network, such that a packet loss concealment delay is reduced on the basis of better utilizing a large amount of remaining uplink bandwidth, and packet loss concealment can be completed with low delay.

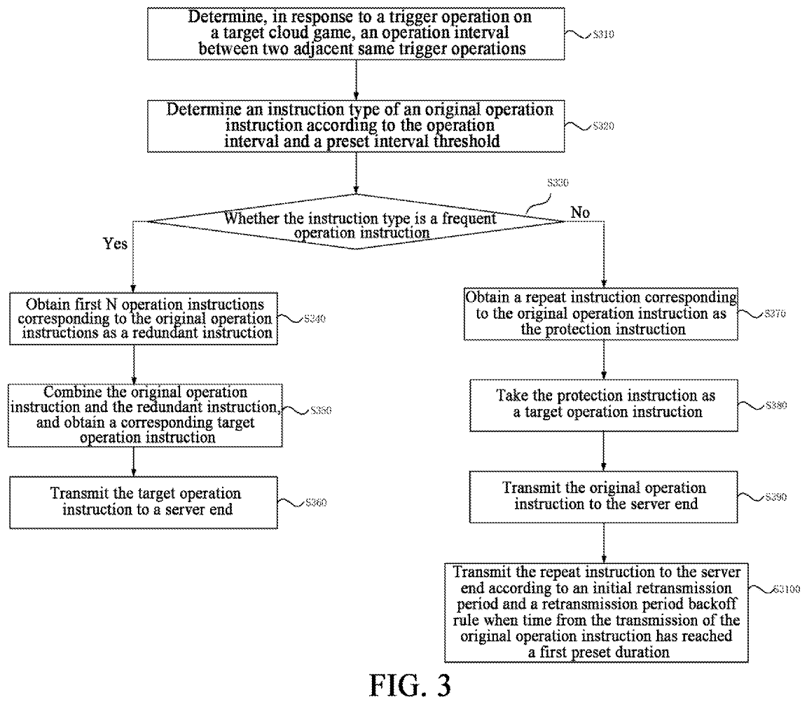

In an example, FIG. 3 is a flowchart of another method for transmitting data provided in an example of the present disclosure. Based on the above example, the example further explains a determination process of the instruction type of the original operation instruction and a determination process of the target operation instruction. As shown in FIG. 3, the method for transmitting data in the example includes:

S310, determine, in response to a trigger operation on a target cloud game, an operation interval between two adjacent same trigger operations.

The operation interval refers to a time interval between a current trigger and a last trigger of the trigger operation. In the example, the time interval of the trigger operation may be determined according to a difference between a current trigger moment and a last trigger moment of the trigger operation. Illustratively, when the trigger operation on the target cloud game is a menu bar click operation, a corresponding original operation instruction is a menu bar click operation instruction. A current trigger moment of the menu bar click operation instruction is moment 1, a last trigger moment is moment 2, and then a time interval between the two adjacent menu bar click operation instructions is taken as the operation interval of the trigger operation, that is, a difference between moment 2 and moment 1 is taken as the operation interval of the menu bar click operation instruction. Certainly, when the difference is negative, an absolute value of the difference can be taken as the operation interval of the menu bar click operation instruction.

S320, determine an instruction type of an original operation instruction according to the operation interval and a preset interval threshold.

In the example, the preset interval threshold refers to a preconfigured time value for distinguishing different instruction types. It can be understood that, when the operation interval is less than the preset interval threshold, the instruction type of the original operation instruction is a frequent operation instruction. When the operation interval is greater than the preset interval threshold, the instruction type of the original operation instruction is an infrequent operation instruction. Illustratively, the preset interval threshold may be 100 ms. Certainly, two different preset interval thresholds may also be used to distinguish the instruction types of the original operation instructions. Illustratively, assuming that the preset interval thresholds may be 10 ms and 100 ms, an instruction type of an original operation instruction with an operation interval less than 10 ms is a frequent operation instruction, and an instruction type of an original operation instruction with an operation interval greater than 100 ms is an infrequent operation instruction.

S330, determine whether the instruction type is a frequent operation instruction, if yes, execute S340; if no, execute S370.

In the example, S340-S360 are executed in case that the instruction type of the original operation instruction is a frequent operation instruction, and S370-S3100 are executed in case that the instruction type of the original operation instruction is an infrequent operation instruction.

S340, obtain first N operation instructions corresponding to the original operation instructions as a redundant instruction.

The first N operation instructions refer to N operation instructions before the current original operation instruction. In the example, the redundant instruction refers to a copy of the original operation instruction.

S350, combine the original operation instruction and the redundant instruction, and obtain a corresponding target operation instruction.

In the example, when the original operation instruction is sent, the first N operation instructions of the original operation instruction are taken as the redundant instruction, the redundant instruction is combined with the original operation instruction, and the corresponding target operation instruction is obtained. A combination process of the original operation instruction and the redundant instruction can also be understood as an assembly process of the original operation instruction and the redundant instruction. That is, the original operation instruction and the redundant instruction are assembled into one instruction, which is recorded as the target operation instruction.

S360, transmit the target operation instruction to a server end.

In the example, the target operation instruction including the redundant instruction and the original operation instruction is sent to the server end, and even if some transmission packets are lost in a network transmission process, after one target operation instruction is transmitted to the server end, the server end may still recover the first N operation instructions of the original operation instruction according to the target operation instruction, such that a better anti-packet-loss effect is achieved, and packet loss concealment is completed with a lower delay.

S370, obtain a repeat instruction corresponding to the original operation instruction as the protection instruction.

The repeat instruction refers to an instruction repeatedly sent by the client end actively. In the example, when the original operation instruction is an infrequent operation instruction, since the operation interval of the instruction is greater than the preset interval threshold, adding only redundant instructions will cause a large delay. Therefore, when the original operation instruction is an infrequent operation instruction, the client end may actively transmit a repeat instruction to the server end, that is, the repeat instruction corresponding to the original operation instruction is taken as a protection instruction.

S380, take the protection instruction as a target operation instruction.

In the example, when the original operation instruction is an infrequent operation instruction, the repeat instruction corresponding to the original operation instruction is directly taken as the target operation instruction.

S390, transmit the original operation instruction to the server end.

In the example, when the original operation instruction is an infrequent operation instruction, the client end directly transmits the original operation instruction to the server end.

S3100, transmit the repeat instruction to the server end according to an initial retransmission period and a retransmission period backoff rule when a time from the transmission of the original operation instruction has reached a first preset duration.

In the example, when a time for the client end to transmit the original operation instruction reaches the first preset duration, the protection instruction of the original operation instruction, that is, the repeat instruction, is repeatedly sent to the server end in an adaptive period until a deadline is reached. The deadline may be a sum of a sent time of the original operation instruction and a minimum instruction response time. The minimum instruction response time refers to a shortest time when ACK information sent by the server end can be received. It can be understood that after the client end obtains the ACK information, a repeat instruction (also called a repeat packet) can be targeted to be sent to the server end. In the example, in the process that the client end transmits the repeat instruction corresponding to the original operation instruction to the server end, in order to prevent frequent transmitting of the repeat instruction from preempting transmitting of the original operation instruction and even causing the phenomenon of over-congestion retention, the repeat instruction may be sent to the server end according to the initial retransmission period and the retransmission period back off rule.

In an example, a method for determining the initial retransmission period includes: determine a remaining bandwidth of a current network where the client end is located according to a current network state; and determine the initial retransmission period according to the remaining bandwidth, a number of bits occupied by each retransmission packet and a minimum instruction response time. The retransmission packet refers to a service packet corresponding to the repeat instruction. Correspondingly, a number of bits occupied by the retransmission packet is configured to represent a size of the retransmission packet in bit. In the example, the client end determines the remaining uplink bandwidth of the current network according to the current network state, determines the initial retransmission period of the repeat instruction according to the remaining uplink bandwidth, the number of bits occupied by each retransmission packet and the minimum instruction response time, and actively retreats from transmitting the repeat instruction when a new original operation instruction is generated, that is, stops transmitting the repeat instruction, and transmits the new original operation instruction. Therefore, the phenomenon that frequent repeat instructions preempt transmitting of original operation instructions and further cause network congestion is prevented.

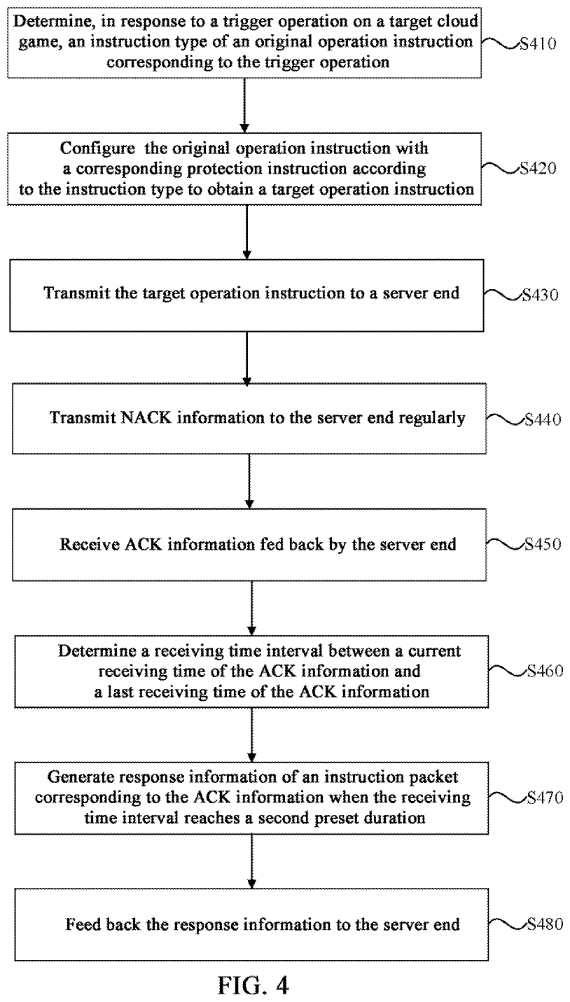

In an example, FIG. 4 is a flowchart of yet another method for transmitting data provided in an example of the present disclosure. In the example, based on the above examples, the original operation instruction is reliably transmitted in a mode of combining ACK and NACK. As shown in FIG. 4, the method for transmitting data in the example includes:
S410, determine, in response to a trigger operation on a target cloud game, an instruction type of an original operation instruction corresponding to the trigger operation.
S420, configure the original operation instruction with a corresponding protection instruction according to the instruction type to obtain a target operation instruction.
S430, transmit the target operation instruction to a server end.
S440, transmits NACK information to the server end regularly.

The NACK information carries serial numbers of all instruction packets not received. In the example, the all instruction packets not received refer to service packets corresponding to all the instructions not received by the server end. In an actual operation process, after the client end transmits the original operation instruction to the server end, or transmits the target operation instruction carrying the original operation instruction and the protection instruction, in case that the server end successfully receives the corresponding instruction, the server end feeds back corresponding ACK information to the client end, such that the client end knows in time that the server end has successfully received the instruction. Correspondingly, the client end may also determine, according to the ACK information, the instructions not successfully received by the server end, and regularly transmit NACK information carrying the serial numbers of all instruction packets not received by the server end to the server end. That is, the NACK information is configured to represent the serial numbers of the instruction packets not successfully received by the server end within a period of time. Illustratively, assuming that a transmitting period of NACK information is 200 ms, the client end transmits the NACK information to the server end once every 200 ms, and the NACK information carries serial numbers of service packets corresponding to all instructions not received by the server end.

S450, receive ACK information fed back by the server end.

In the example, when the server end successfully receives the instruction sent by the client end, the server end feeds back corresponding ACK information to the client end. It can be understood that each successfully received instruction corresponds to a piece of ACK message.

S460, determine receiving time interval between a current receiving time of the ACK information and a last receiving time of the ACK information.

The receiving time interval refers to a receiving time interval of two adjacent pieces of ACK information. In the example, the receiving time interval is determined according to a difference between a last receiving time and a current receiving time of ACK information. Illustratively, assuming that the current receiving time of the ACK information is moment 3, and the last receiving time is moment 4, an absolute value of a difference between moment 4 and moment 3 is taken as the receiving time interval.

S470, generate response information of an instruction packet corresponding to the ACK information when the receiving time interval reaches a second preset duration.

The response information includes serial numbers of all instruction packets not received within the receiving time interval. In the example, when the receiving time interval between two pieces of ACK information reaches the second preset duration, ACK is performed on the instruction packet corresponding to the current ACK information, that is, corresponding response information is generated. Illustratively, assuming that the current receiving time of the ACK information is moment 3, and the last receiving time is moment 4, all instruction packets not received and carried in the response information refer to all instruction packets not successfully received by the server end between moment 3 and moment 4. The response information refers to information responding to the instruction packets transmitted at moment 4.

S480, feedback the response information to the server end.

In the example, the client end transmits response information of serial numbers of all instruction packets not received in the receiving time interval to the server end, such that the server end knows all instructions not successfully received in the receiving time interval in time.

It should be noted that S450 may be executed before S440, that is, the client end knows all the instructions not successfully received by the server end according to the ACK information fed back by the server end. Certainly, the client end may also know all the instructions not successfully received by the server end according to other methods, that is, S450 is executed after S440.

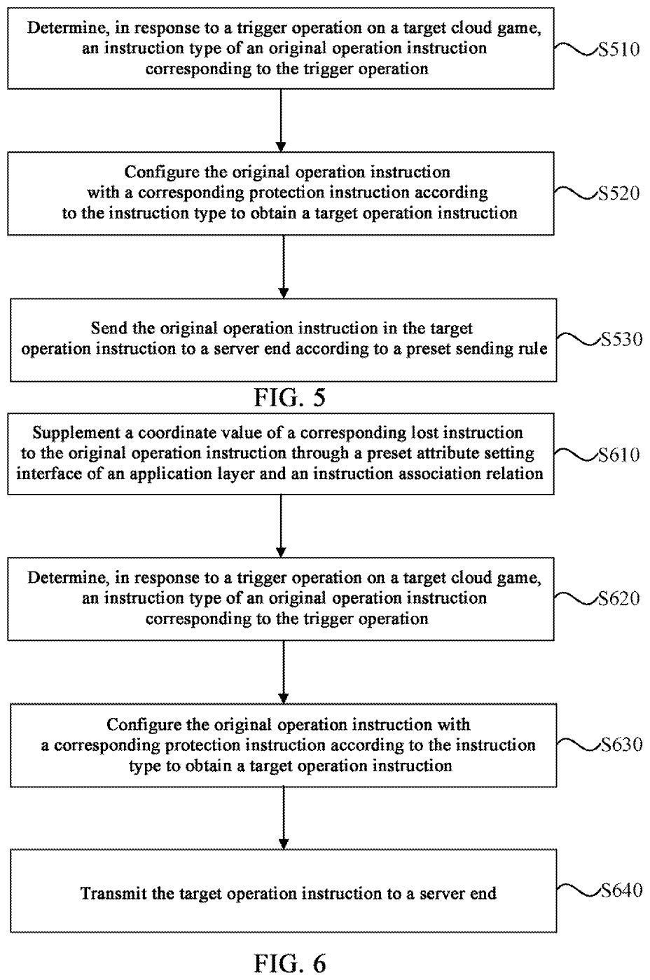

In an example, FIG. 5 is a flowchart of still another method for transmitting data provided in an example of the present disclosure. In the example, congestion control in a data transmission process is described on the basis of the above examples. The example is applied to a scene where a current uplink bandwidth of the network where the client end is located is lower than a preset bandwidth threshold. It can be understood as a situation where the uplink bandwidth of the network where the client end is located is insufficient. As shown in FIG. 5, the method for transmitting data in the example includes:

S510, determine, in response to a trigger operation on a target cloud game, an instruction type of an original operation instruction corresponding to the trigger operation.

S520, configure the original operation instruction with a corresponding protection instruction according to the instruction type to obtain a target operation instruction.

S530, transmit the original operation instruction in the target operation instruction to a server end according to a preset transmission rule.

The preset transmission rule satisfies the following conditions: a congestion window (CWND) or a rate control strategy is not followed; and a number of the protection instruction in the target operation instruction is reduced. In the example, a CWND is not followed refers to immediately transmitting the original operation instruction to the server end without being restricted by the CWND. Alternatively, a rate control strategy is not followed refers to immediately transmitting the original operation instruction to the server end without being restricted by the rate control strategy, such that a delay and network channel preemption are reduced as much as possible. It should be noted that, in the example of the present disclosure, the uplink bandwidth is fully used to achieve an effect of minimizing a packet loss concealment delay. That is, the uplink bandwidth in a link of the network where the client end is located needs to be measured. But in the case of an insufficient uplink bandwidth, in order to avoid aggravation of network congestion, corresponding congestion control needs to be performed to avoid increase in network delay, that is, the original operation instruction is sent to the server end according to a preset transmission rule. The preset transmission rule may satisfy the following two conditions: the original operation instruction is not limited by the CWND or rate control strategy, that is, the original operation instruction is sent immediately, so as to reduce the delay and network channel preemption as much as possible; and alternatively, when network congestion is detected, transmitting of the protection instructions is reduced, that is, the number of protection instructions in the target operation instruction is reduced.

In an example, FIG. 6 is a flowchart of still another method for transmitting data provided in an example of the present disclosure. Based on the above examples, the example describes a process of configuring instruction attributes of a service layer corresponding to the original operation instruction. As shown in FIG. 6, the method for transmitting data in the example includes:

S610, supplement a coordinate value of a corresponding lost instruction to the original operation instruction through a preset attribute setting interface of an application layer and an instruction association relation.

In the example, the preset attribute setting interface refers to an interface reserved by a transmission layer for attribute setting of an application layer. A reliability requirement of an instruction packet corresponding to the original operation instruction can be specified through the preset attribute setting interface.

It should be noted that the original operation instruction may be a service layer instruction. Moreover, there is a certain association between the service layer instructions. In an actual operation process, some missing instruction data, such as a coordinate value of a lost instruction, can be actively supplemented by means of the instruction association, such that reliability of the instruction is improved.

S620, determine, in response to a trigger operation on a target cloud game, an instruction type of an original operation instruction corresponding to the trigger operation.

S630, configure the original operation instruction with a corresponding protection instruction according to the instruction type to obtain a target operation instruction.

S640, transmit the target operation instruction to a server end.

According to the technical solution of the example, based on the above examples, based on a correlation of the service layer instructions, the transmission layer can adapt to reliability requirements of different service data, and assist the service layer in completing active recovery of instructions, to avoid retransmission.

In an example, the following four instructions are taken as an example to describe a process for transmitting data. Illustratively, instruction data includes: a base instruction (recorded as BasePack), which is an instruction actually sent by a user; a redundant instruction (recorded as RedunPack), which is a copy of a transmitted instruction appended to a currently transmitted instruction packet; a repeat instruction (recorded as RepeatPack), which is an instruction actively and repeatedly sent; and a retransmission instruction (RtransPack), which is an instruction passively retransmitted in response to NACK requests. The base instruction can be understood as the original operation instruction in the above examples. The redundant instruction or the repeat instruction is the protection instruction in the above examples.

In order to make full use of the upstream bandwidth of the instruction, the protection instruction is added to the BasePack, and is mainly composed of a RedunPack and a RepeatPack.

### Case 1: The Protection Instruction is a RedunPack

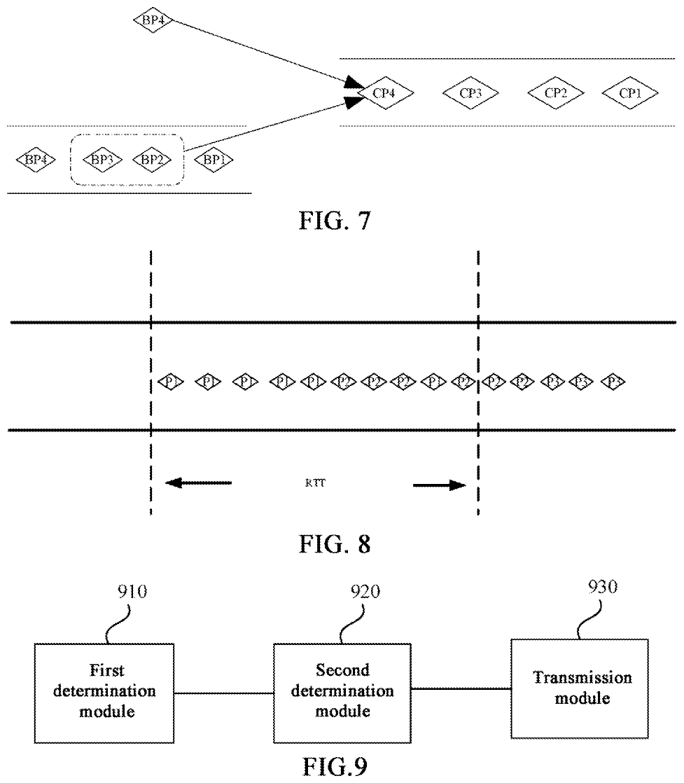

FIG. 7 is a schematic diagram of transmission with a redundant instruction as a protection instruction provided in an example of the present disclosure. As shown in FIG. 7, when the BasePack is sent, the first N BasePacks are taken as a RedunPack and assembled into a BasePack, to form a CombiPack. In this way, even if some transmission packets are lost in network transmission, when one CombiPack arrives, the first N BasePacks can still be recovered. For example, it is observed that generally at most three instructions action_down, action_move, action_up form one independent action, then three service packets are combined into a transmission packet, that is, one or two of the first packet and the second packet are lost, and the third packet can be executed immediately after received. Through instruction collection data, it is observed that under a scene that a user slides a touch screen and frequently transmits user instructions, an operation interval of the instructions is about 10 ms. The RedunPack can have a desirable anti-packet-loss effect when a user frequently transmits instructions, and complete packet loss concealment with a low latency.

### Case 2: The Protection Instruction is a RepeatPack

FIG. 8 is a schematic diagram of transmission with a repeat instruction as a protection instruction provided in an example of the present disclosure. As shown in FIG. 8, although RedunPack has a desirable anti-packet-loss effect when a user frequently operates, when the user touches a screen infrequently, such as clicking a menu bar, game settings, etc. An operation interval of different instructions is generally greater than 100 ms, and only adding RedunPack introduces a large delay, such that RepeatPack is introduced. Within a period of time after an instruction packet BasePack(N) is sent, a repeat packet RepeatPack(N) of the BasePack(N) is repeatedly sent with an adaptive period until a deadline T (BasePack(N))+RTT is reached. RTT refers to a time when ACK can be obtained fastest (that is, a minimum instruction response time in the above example). The repeat packet (that is, a service packet corresponding to a repeat instruction) can be sent after ACK is obtained. The initial retransmission period of RepeatPack(N) needs to be adaptive according to a network state. When a new BasePack is generated, the RepeatPack(N) also needs to implement active backoff transmission, so as to prevent frequent RepeatPack(N) from preempting transmission of the BasePack(N) and even causing network congestion.

In the example, the initial retransmission period and a retransmission period backoff rule of the RepeatPack are as follows.

The initial retransmission period of the RepeatPack:

$${T ( N )}_{start} = factor * \frac{size ( basepack ( N ) ) * RTT}{( {bandwidth}_{total} - {bandwidth}_{basepack} )}$$

The retransmission period backoff rule of the RepeatPack:

$$T ( N ) = \frac{T ( N + k )}{{2}^{k}}$$

$${bandwidth}_{total} - {bandwidth}_{base pack} = {bandwidth}_{remain} .$$

A remaining bandwidth is estimated according to the current network state of the client end. size(basepack(N)) is a size of a retransmission packet in bit. bandwidthᵣₑₘₐᵢₙ is configured to indicate the remaining bandwidth; bandwidthₜₒₜₐₗ is configured to indicate a total uplink bandwidth of the network where the client end is currently located; and bandwidth_{basepack} is configured to indicate an uplink bandwidth used by the network where the client is currently located.

$$\frac{RTT}{T ( N )} * size ( basepack ( N ) ) = {bandwidth}_{remain} ,$$

and it can be concluded that T(N)ₛₜₐᵣₜ is a theoretical maximum anti-packet-loss retransmission period within a limited time limit.

factor can be configured to adjust T(N) according to actual application scenes, so as to better adapt to the network. Illustratively, factor may be a constant value.

In an example, instruction reliability is guaranteed in a mode of combining ACK and NACK. In the example, with a transmitting period of NACK information being 200 ms and a receiving time interval being 20 ms as an example, an information feedback mechanism is as follows.

NACK information is sent once every 200 ms, where serial numbers of all instruction packets that are not received and carried in a payload of the NACK information are recorded as nack list; and

an instruction packet whose interval from last ACK information exceeds 20 ms is received, ACK is performed on the instruction packet, that is, ACK seq=P, and serial numbers of instruction packets not received within 20 ms and carried in a payload are recorded as nack list.

In the example, when the nack list is large, a packet loss mode is detected, and a reasonable repeat packet is added (for example, a repeat window is expanded to more than one RTT, and a multiple instruction repeat packet interleaving ratio is adjusted), such that a service packet loss rate is reduced. When the nack list is 0 for a long time, a previous repeat packet mode is restored.

In an example, the instruction transmission channel in the examples of the present disclosure minimizes a packet loss concealment delay by fully utilizing the bandwidth, such that in the example, an uplink bandwidth in a current network link needs to be measured. In an extreme case, that is, in the case of an insufficient uplink bandwidth, the instruction channel must implement corresponding congestion control, and otherwise, additional protection data aggravates network congestion, resulting in increased a network delay. In the example, the network bandwidth is detected by BCC, and the following two transmission rules are added.

BasePack, which is not limited by CWND or pacing_rate (that is, a rate control strategy), is sent immediately, so as to reduce a delay and network channel preemption as much as possible. Since a data size of a basic instruction is very small, it is expected that an influence on congestion is small.

When congestion is detected, transmitting of a protection instruction (RedunPack, RepeatPack) is reduced.

In an example, a transmission layer reserves an attribute setting interface (that is, a preset attribute setting interface) for an application layer, and a reliability requirement of a packet can be specified through the attribute interface.

For example, there is a certain instruction association between instruction data of a service layer. By using the instruction association, some missing instruction data may be actively supplemented. For example, a button click action in a game generates at least two specified items, one item is ACTION_DOWN and one item is ACTION_UP. The service layer receives two ACTION_DOWN, finds a loss packet in combination the transmission serial number, and can supplement one ACTION_UP with the same coordinates as the first item between the two ACTION_DOWN.

For example, as for a series of ACTION_MOVE instructions towards a same direction, coordinates of a missing MOVE instruction may be estimated from coordinates of previous and next MOVE instructions.

In the case of an insufficient bandwidth (generally 200 k), the example of the present disclosure can still adapt to a network well, transmitting of a protection instruction is reduced, the reliability is mainly guaranteed by ACK & NACK, and the TCP has a packet contamination phenomenon, that is, the example has a lower packet loss concealment delay than that of the TCP.

In an example, FIG. 9 is a structural block diagram of an apparatus for transmitting data provided in an example of the present disclosure. As shown in FIG. 9, the apparatus for transmitting data in the example includes a first determination module 910, a second determination module 920 and a transmission module 930.

The first determination module 910 is configured to determine, in response to a trigger operation on a target cloud game, an instruction type of an original operation instruction corresponding to the trigger operation;
the second determination module 920 is configured to configure the original operation instruction with a corresponding protection instruction according to the instruction type to obtain a target operation instruction; and
a transmission module 930 is configured to transmit the target operation instruction to a server end.

In an example, the first determination module 910 includes:
a first determination unit configured to determine an operation interval between two adjacent same trigger operations; and
a second determination unit configured to determine the instruction type of the original operation instruction according to the operation interval and a preset interval threshold.

In an example, in case that the instruction type is a frequent operation instruction, the second determination module includes:
a first obtaining unit configured to obtain first N operation instructions corresponding to the original operation instructions as a redundant instruction; and
a combining unit configured to combine the original operation instruction and the redundant instruction, and obtain the corresponding target operation instruction.

In an example, in case that the instruction type is an infrequent operation instruction, the second determination module includes:
a second obtaining unit configured to obtain a repeat instruction corresponding to the original operation instruction as the protection instruction; and
a third determination unit configured to take the protection instruction as the target operation instruction.

In an example, the transmission module includes:
a first transmitting unit configured to transmit the original operation instruction to the server end; and
a second transmitting unit configured to transmit the repeat instruction to the server end according to an initial retransmission period and a retransmission period backoff rule when a time from the transmission of the original operation instruction has reached a first preset duration.

In an example, a method for determining the initial retransmission period includes:
determine a remaining bandwidth of a current network where the client end is located according to a current network state; and
determine the initial retransmission period according to the remaining bandwidth, a number of bits occupied by each retransmission packet and a minimum instruction response time.

In an example, the apparatus for transmitting data applied to a client end further includes:
a first transmitting module configured to transmit non-acknowledgement (NACK) information to the server end regularly, where the NACK information carries serial numbers of all instruction packets not received.

In an example, the apparatus for transmitting data applied to a client end further includes:
a reception module configured to receive ACK information fed back by the server end;
a second determination module configured to determine a receiving time interval between a current receiving time of the ACK information and a last receiving time of the ACK information;
a generation module configured to generate response information of an instruction packet corresponding to the ACK information when the receiving time interval reaches a second preset duration, where the response information includes serial numbers of all instruction packets not received within the receiving time interval; and
a feedback module configured to feed back the response information to the server end.

In an example, when a current uplink bandwidth of a network where the client end is located is lower than a preset bandwidth threshold, the transmission module is specifically configured to transmit the original operation instruction in the target operation instruction to the server end according to a preset transmission rule; where
the preset transmission rule satisfies the following conditions: a congestion window (CWND) or a rate control strategy is not followed; and a number of the protection instruction in the target operation instruction is reduced.

In an example, the apparatus for transmitting data applied to a client end is further configured to:
supplement a coordinate value of a corresponding lost instruction to the original operation instruction through a preset attribute setting interface of an application layer and an instruction association relation.

The apparatus for transmitting data can execute the method for transmitting data applied to a client end and provided in any example of the present disclosure, and has corresponding functional modules and beneficial effects for executing the methods.

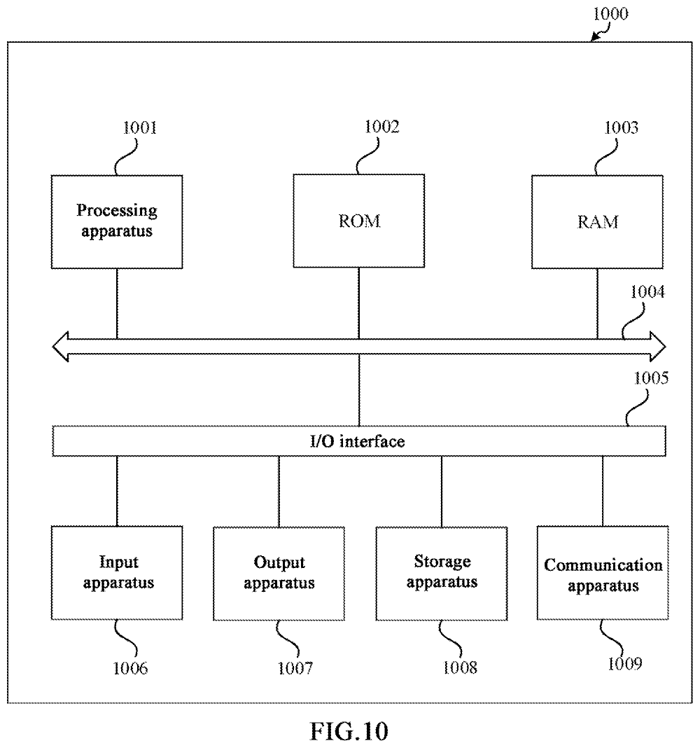

FIG. 10 is a structural block diagram of an electronic device provided in an example of the present disclosure. With reference to FIG. 10 below, a schematic structural diagram of an electronic device (for example, a terminal device, a server, or a computer) 1000 suitable for implementing an example of the present disclosure is shown. The computer in the example of the present disclosure may include, but is not limited to, mobile terminals such as mobile phones, notebook computers, digital broadcast receivers, personal digital assistants (PDA), tablet computers (PAD), portable multimedia players (PMP), in-vehicle terminals (for example, in-vehicle navigation terminals), etc., and fixed terminals such as digital televisions (TV), desktop computers, etc. The electronic device illustrated in FIG. 10 is merely an instance and should not impose any limitation on the functions and scope of use of the examples of the present disclosure.

As shown in FIG. 10, the electronic device 1000 may include a processing apparatus (for example, a central processing unit, a graphics processing unit, etc.) 1001 that may execute various appropriate actions and processes according to programs stored in a read-only memory (ROM) 1002 or programs loaded from a storage apparatus 1006 into a random-access memory (RAM) 1003. The RAM 1003 also stores various programs and data needed for the operations of the electronic device 1000. The processing apparatus 1001, the ROM 1002, and the RAM 1003 are connected to each other by means of a bus 1004. An input/output (I/O) interface 1005 is also connected to the bus 1004.

Typically, the following apparatuses may be connected to the I/O interface 1005: an input apparatus 1006 including, for example, a touch screen, a touch pad, a keyboard, a mouse, a camera, a microphone, an accelerometer, a gyroscope, etc.; an output apparatus 1007 including, for example, a liquid crystal display (LCD), a speaker, a vibrator, etc.; a storage apparatus 1006 including, for example, a magnetic tape, a hard disk, etc.; and a communication apparatus 1009. The communication apparatus 1009 may allow the electronic device 1000 to be in wireless or wired communication with other devices to exchange data. While the FIG. 10 illustrates an electronic device 1000 having various apparatuses, it should be understood that not all of the illustrated apparatuses are required to be implemented or provided. More or fewer apparatus may alternatively be implemented or provided.

In particular, according to examples of the present disclosure, a processes described above with reference to the flowcharts may be implemented as a computer software program. For example, examples of the present disclosure include a computer program product. The computer program product includes a computer program carried on a non-transitory computer-readable medium, and the computer program includes a program code for executing the method illustrated in the flowchart. In such examples, the computer program may be downloaded and installed from a network by means of the communication apparatuses 1009, or installed from 10) the storage device 1006, or installed from the ROM 1002. When executed by the processing apparatus 1001, the computer program executes the above-described functions defined in the method of the example of the present disclosure.

It should be noted that the computer-readable medium in the present disclosure may be a computer-readable signal medium or a computer-readable storage medium, or any combination of a computer-readable signal medium and a computer-readable storage medium. The computer-readable storage medium may include, but is not limited to, an electronic, magnetic, optical, electromagnetic, infrared, or semiconductor system, apparatus, or device, or any combination of the foregoing. More specific instance of the computer-readable storage medium may include, but is not limited to, an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium that includes or stores a program for use by or in conjunction with an instruction execution system, apparatus, or device. In the present disclosure, the compute-readable signal medium may include a data signal propagating in a baseband or as part of a carry wave and carrying a computer-readable program code. Such a propagated data signal may have a variety of forms and may include, but is not limited to, an electromagnetic signal, an optical signal, or any suitable combination of the foregoing. The computer-readable signal medium may also be any computer-readable medium besides a computer-readable storage medium. The computer-readable signal medium can transmit, propagate, or transmit a program for use by or in conjunction with an instruction execution system, apparatus, or device. A program code included on a computer-readable medium may be transmitted by means of any suitable medium, including, but not limited to, wires, fiber optic cables, radio frequency (RF), etc., or any suitable combination of the foregoing.

In some embodiments, a client end and a server may communicate by using any currently known or future developed network protocol, such as a hypertext transfer protocol (HTTP), and may be interconnected with any form or medium of digital data communication (for example, a communication network). Instances of communication networks include a local area network (LAN), a wide area network (WAN), Internet work (for example, the Internet), and an end-to-end network (for example, an ad hoc end-to-end network), as well as any currently known or future developed network.

The computer-readable medium may be included in the above electronic device, and may also exist independently without being assembled into the electronic device.

The computer-readable medium carries one or more programs. When the one or more programs are executed by the electronic device, the electronic device is caused to: determine, in response to a trigger operation on a target cloud game, an instruction type of an original operation instruction corresponding to the trigger operation; configure the original operation instruction with a corresponding protection instruction according to the instruction type to obtain a target operation instruction; and transmit the target operation instruction to a server end.

A computer program code for performing operations of the present disclosure may be written in one or more programming languages, or combinations of the programming languages. The programming languages include, but are not limited to, object-oriented programming languages, such as Java, Smalltalk, and C++, and further include conventional procedural programming languages, such as the C programming language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected with a user computer through any kind of network, including a local area network (LAN) or a wide area network (WAN), or may be connected with an external computer (for example, connected through the Internet by using an Internet service provider).

The flowcharts and block diagrams in the accompanying drawings illustrate the architecture, functionality, and operations possibly implemented by the systems, methods, and computer program products according to various examples of the present disclosure. In this regard, each block in the flowcharts or block diagrams may represent a module, a program segment, or part of a code, and a module, a program segment, or part of a code includes one or more executable instructions for implementing a specified logical function. It should also be noted that in some alternative implementations, a function noted in a block may occur in a different order than an order noted in the figures. For example, two consecutive blocks may actually be executed substantially in parallel, or in a reverse order sometimes, depending on a function involved. It should also be noted that each block in the block diagrams and/or flowcharts, and combinations of blocks in the block diagrams and/or flowcharts, can be implemented by special purpose hardware-based systems that perform specified functions or operations, or can be implemented by combinations of special purpose hardware and computer instructions.

The units described in the example of the present disclosure may be implemented in software or hardware. The name of a unit does not constitute a limitation on the unit itself under certain circumstances. For example, the first obtaining unit may also be described as “a unit obtaining at least two internet protocol addresses”.

The functions described above herein may be executed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, the machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific instance of the machine-readable storage medium may include an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more examples of the present disclosure, a method and apparatus, device, and medium for transmitting data applied to a client end are provided. The method includes: determine, in response to a trigger operation on a target cloud game, an instruction type of an original operation instruction corresponding to the trigger operation; configure the original operation instruction with a corresponding protection instruction according to the instruction type to obtain a target operation instruction; and transmit the target operation instruction to a server end.

According to one or more examples of the present disclosure, a method, apparatus, device, and medium for transmitting data applied to a client end are provided. The step of determining an instruction type of an original operation instruction corresponding to the trigger operation includes: determine an operation interval between two adjacent same trigger operations; and determine the instruction type of the original operation instruction according to the operation interval and a preset interval threshold.

According to one or more examples of the present disclosure, a method, apparatus, device, and medium for transmitting data applied to a client end are provided. In case that the instruction type is a frequent operation instruction, the step of configuring the original operation instruction with a corresponding protection instruction according to the instruction type to obtain a target operation instruction includes: obtain first N operation instructions corresponding to the original operation instructions as a redundant instruction; and combine the original operation instruction and the redundant instruction, and obtain the corresponding target operation instruction.

According to one or more examples of the present disclosure, a method, apparatus, device, and medium for transmitting data applied to a client end are provided. In case that the instruction type is an infrequent operation instruction, the step of configuring the original operation instruction with a corresponding protection instruction according to the instruction type to obtain a target operation instruction includes: obtain a repeat instruction corresponding to the original operation instruction as the protection instruction; and take the protection instruction as the target operation instruction.

According to one or more examples of the present disclosure, method, apparatus, device, and medium for transmitting data applied to a client end are provided. The step of transmitting the target operation instruction to a server end includes: transmit the original operation instruction to the server end; and transmit the repeat instruction to the server end according to an initial retransmission period and a retransmission period backoff rule when time from the transmission of the original operation instruction has reached a first preset duration.

According to one or more examples of the present disclosure, a method, apparatus, device, and medium for transmitting data applied to a client end are provided. A method for determining the initial retransmission period includes:
determine a remaining bandwidth of a current network where the client end is located according to a current network state; and
determine the initial retransmission period according to the remaining bandwidth, a number of bits occupied by each retransmission packet and a minimum instruction response time.

According to one or more examples of the present disclosure, a method, apparatus, device, and medium for transmitting data applied to a client end are provided. The method for transmitting data applied to a client end further includes:
transmit non-acknowledgement (NACK) information to the server end regularly, where the NACK information carries serial numbers of all instruction packets not received.

According to one or more examples of the present disclosure, a method, apparatus, device, and medium for transmitting data applied to a client end are provided. The method for transmitting data applied to a client end further includes: receive ACK information fed back by the server end;
determine a receiving time interval between a current receiving time of the ACK information and a last receiving time of the ACK information;
generate response information of an instruction packet corresponding to the ACK information when the receiving time interval reaches a second preset duration, where the response information includes serial numbers of all instruction packets not received within the receiving time interval; and
feedback the response information to the server end.

According to one or more examples of the present disclosure, a method, apparatus, device, and medium for transmitting data applied to a client end are provided. The step of transmitting the target operation instruction to the server end when a current uplink bandwidth of a network where the client end is located is lower than a preset bandwidth threshold includes:
transmit the original operation instruction in the target operation instruction to the server end according to a preset transmission rule; where
the preset transmission rule satisfies the following conditions: a congestion window (CWND) or a rate control strategy is not followed; and a number of the protection instruction in the target operation instruction is reduced.

According to one or more examples of the present disclosure, a method, apparatus, device, and medium for transmitting data applied to a client end are provided. The method for transmitting data applied to a client end further includes: supplement a coordinate value of a corresponding lost instruction to the original operation instruction through a preset attribute setting interface of an application layer and an instruction association relation.

The above description is merely illustrative of preferred examples of the present disclosure and principles of the technology employed. It should be understood by those skilled in the art that the disclosed scope involved in the present disclosure is not limited to the technical solutions in which the above-described technical features are specifically combined, but encompasses other technical solutions in which the above-described technical features or equivalent features thereof are arbitrarily combined without departing from the concept of the present disclosure, for example, technical solutions formed by interchanging the features described above with (non-limitative) technical features disclosed in the present disclosure that have similar functions.

Furthermore, although operations are depicted in a particular order, this should not be understood as requiring that such operations be performed in the particular order shown or in a sequential order. In certain circumstances, multitasking and parallel processing may be advantageous. Similarly, although several specific implementation details are included in the above discussion, these details should not be construed as limitations on the scope of the present disclosure. Some features that are described in the context of separate examples may also be implemented in combination in a single example. Conversely, various features described in the context of a single example can also be implemented in multiple examples separately or in any suitable sub-combination manner.

Although the subject matter has been described in language specific to structural features and/or methodological logical actions, it should be understood that the subject matter defined in the appended claims is not necessarily limited to the specific features or actions described above. On the contrary, the specific features and actions described above are merely instance forms of implementing the claims.

1. A data transmission method applied at a client end, comprising:
determining, in response to a trigger operation on a target cloud game, an instruction type of an original operation instruction corresponding to the trigger operation;
configuring the original operation instruction with a corresponding protection instruction according to the instruction type to obtain a target operation instruction; and
transmitting the target operation instruction to a server end.

2. The method of claim 1, wherein determining an instruction type of an original operation instruction corresponding to the trigger operation comprises:
determining an operation interval between two adjacent same trigger operations; and
determining the instruction type of the original operation instruction according to the operation interval and a preset interval threshold.

3. The method of claim 1, wherein in case that the instruction type is a frequent operation instruction, configuring the original operation instruction with a protection instruction according to the instruction type to obtain a target operation instruction comprises:
obtaining first N operation instructions corresponding to the original operation instructions as a redundant instruction; and
combining the original operation instruction and the redundant instruction to obtain the corresponding target operation instruction.

4. The method of claim 1, wherein in case that the instruction type is an infrequent operation instruction, configuring the original operation instruction with a corresponding protection instruction according to the instruction type to obtain a target operation instruction comprises:
obtaining a repeat instruction corresponding to the original operation instruction as the protection instruction; and
taking the protection instruction as the target operation instruction.

5. The method of claim 4, wherein transmitting the target operation instruction to the server end comprises:
transmitting the original operation instruction to the server end; and
transmitting the repeat instruction to the server end according to an initial retransmission period and a retransmission period backoff rule in response to time from the transmission of the original operation instruction has reached a first preset duration.

6. The method of claim 5, wherein a method for determining the initial retransmission period comprises:
determining a remaining bandwidth of a current network where the client end is located according to a current network state; and
determining the initial retransmission period according to the remaining bandwidth, a number of bits occupied by each retransmission packet and a minimum instruction response time.

7. The method of claim 1, further comprising:
transmitting non-acknowledgement (NACK) information to the server end regularly, wherein the NACK information carries serial numbers of all instruction packets that are not received.

8. The method of claim 1, further comprising:
receiving ACK information fed back by the server end;
determining a receiving time interval between a current receiving time of the ACK information and a last receiving time of the ACK information;
generating response information of an instruction packet corresponding to the ACK information in response to the receiving time interval reaches a second preset duration, wherein the response information comprises serial numbers of all instruction packets not received within the receiving time interval; and
feeding back the response information to the server end.

9. The method of claim 1, wherein transmitting the target operation instruction to the server end in response to a current uplink bandwidth of a network where the client end is located is lower than a preset bandwidth threshold comprises:
transmitting the original operation instruction in the target operation instruction to the server end according to a preset transmission rule; wherein
the preset transmission rule satisfies the following conditions: a congestion window (CWND) or a rate control strategy is not followed; and a number of the protection instruction in the target operation instruction is reduced.

10. The method of claim 1, further comprising:
supplementing a coordinate value of a corresponding lost instruction to the original operation instruction through a preset attribute setting interface of an application layer and an instruction association relation.

11. (canceled)

12. An electronic device, comprising:
one or more processors; and
a memory configured to store one or more programs;
wherein the one or more programs, when executed by the one or more processors, cause the one or more processors to:
determine, in response to a trigger operation on a target cloud game, an instruction type of an original operation instruction corresponding to the trigger operation;
configure the original operation instruction with a corresponding protection instruction according to the instruction type to obtain a target operation instruction; and
transmit the target operation instruction to a server end.

13. A computer storage medium, storing a computer program, wherein the computer program, when executed by a processor, cause the processor to:
determine, in response to a trigger operation on a target cloud game, an instruction type of an original operation instruction corresponding to the trigger operation;
configure the original operation instruction with a corresponding protection instruction according to the instruction type to obtain a target operation instruction; and
transmit the target operation instruction to a server end.

14. The electronic device of claim 12, wherein the electronic device is caused to determine an instruction type of an original operation instruction corresponding to the trigger operation by:
determining an operation interval between two adjacent same trigger operations; and
determining the instruction type of the original operation instruction according to the operation interval and a preset interval threshold.

15. The electronic device of claim 12, wherein in case that the instruction type is a frequent operation instruction, configuring the original operation instruction with a protection instruction according to the instruction type to obtain a target operation instruction comprises:
obtaining first N operation instructions corresponding to the original operation instructions as a redundant instruction; and
combining the original operation instruction and the redundant instruction to obtain the corresponding target operation instruction.

16. The electronic device of claim 12, wherein in case that the instruction type is an infrequent operation instruction, configuring the original operation instruction with a corresponding protection instruction according to the instruction type to obtain a target operation instruction comprises:
obtaining a repeat instruction corresponding to the original operation instruction as the protection instruction; and
taking the protection instruction as the target operation instruction.

17. The electronic device of claim 14, wherein the electronic device is caused to transmit the target operation instruction to the server end by:
transmitting the original operation instruction to the server end; and
transmitting the repeat instruction to the server end according to an initial retransmission period and a retransmission period back off rule in response to time from the transmission of the original operation instruction has reached a first preset duration.

18. The electronic device of claim 15, wherein the electronic device is caused to determine the initial retransmission period by:
determining a remaining bandwidth of a current network where the client end is located according to a current network state; and
determining the initial retransmission period according to the remaining bandwidth, a number of bits occupied by each retransmission packet and a minimum instruction response time.

19. The electronic device of claim 12, the electronic device is further caused to:
transmit non-acknowledgement (NACK) information to the server end regularly, wherein the NACK information carries serial numbers of all instruction packets that are not received.

20. The electronic device of claim 12, the electronic device is further caused to:
receive ACK information fed back by the server end;
determine a receiving time interval between a current receiving time of the ACK information and a last receiving time of the ACK information;
generate response information of an instruction packet corresponding to the ACK information in response to the receiving time interval reaches a second preset duration, wherein the response information comprises serial numbers of all instruction packets not received within the receiving time interval; and
feedback the response information to the server end.

21. The electronic device of claim 12, wherein the electronic device is further caused to transmitting the target operation instruction to the server end in response to a current uplink bandwidth of a network where the client end is located is lower than a preset bandwidth threshold by:
transmitting the original operation instruction in the target operation instruction to the server end according to a preset transmission rule; wherein
the preset transmission rule satisfies the following conditions: a congestion window (CWND) or a rate control strategy is not followed; and a number of the protection instruction in the target operation instruction is reduced.
